(19) United States
(12) Patent Application Publication
(10) Pub. No.: US 2012/0256497 A1
(43) Pub. Date: Oct. 11, 2012

(54) BATTERY PACK AND POWER SUPPLY SYSTEM WITH THE SAME

(75) Inventor: HSIUNG-WEI SUNG, Tu-Cheng (TW)

(73) Assignee: HON HAI PRECISION INDUSTRY CO., LTD., Tu-Cheng (TW)

(21) Appl. No.: 13/241,160

(22) Filed: Sep. 22, 2011

(30) Foreign Application Priority Data
Apr. 11, 2011 (CN) 201110089473.X

(51) Int. Cl. H02J 1/00

(52) U.S. Cl. 307/150

(57) ABSTRACT

A power supply system includes a battery pack and an electronic device. The battery pack includes a battery, a voltage conversion circuit, and a first power port. The electronic device includes a second power port. When the battery pack is connected to the electronic device via the first power port and the second power port, the connection between the battery and the voltage conversion circuit is established, the voltage conversion circuit converts a voltage of the battery to a predetermined voltage and power the electronic device via the first power port and the second power port; when the battery pack does not connect to the electronic device, the connection between the battery and the voltage conversion circuit is cut off.

### BACKGROUND

1. Technical Field

The present disclosure relates to batteries, particularly, to a battery pack.

2. Description of Related Art

Presently, electronic devices such as portable computers, mobile phones are equipped with an external battery pack to power the electronic devices if a built-in battery of the electronic device has been exhausted. Referring to FIG. 2, a conventional battery pack 10 includes a battery S, a voltage conversion circuit 20, and a power port 30. The voltage conversion circuit 20 converts the voltage of the battery S to a predetermined voltage for an electronic device 40, and power the electronic device 40 via the power port 30. The conventional battery pack 10 also includes a switch K connected between the battery 10 and the voltage conversion circuit 20, when the battery pack 10 does not power the electronic device 40, the switch K is switched off to cut off the connection between the battery 10 and the voltage conversion circuit 20. However, in the conventional battery pack 10, the switch K needs to be operated by a user. If the user forgets to turn off the switch K when the battery pack 10 is disconnected from the electronic device 40, the voltage conversion circuit 20 will remain in working state and waste power.

Therefore, it is desirable to provide a battery pack to overcome the described limitations.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure.

Moreover, in the drawings, like reference numerals designate corresponding parts throughout the several views.

FIG. 1 is a schematic diagram of a power supply system with a battery pack, in accordance with an exemplary embodiment.

FIG. 2 is a schematic diagram of a battery pack in the related art.

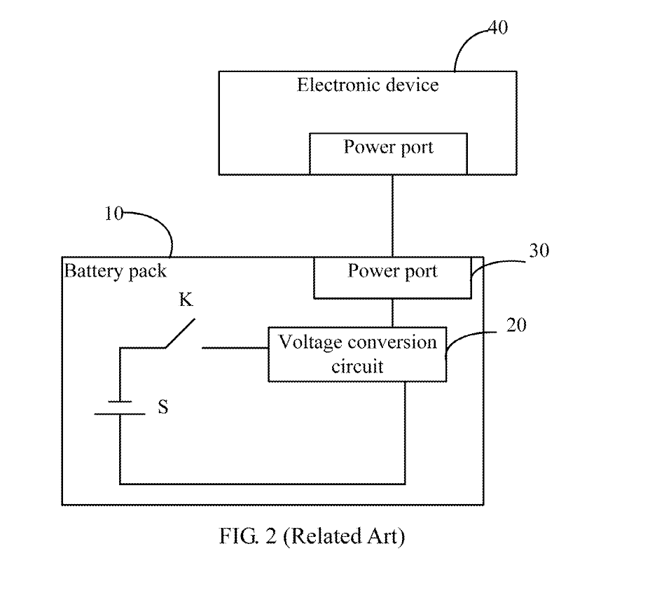

### DETAILED DESCRIPTION

Embodiments of the present disclosure will now be described in detail, with reference to the accompanying drawings.

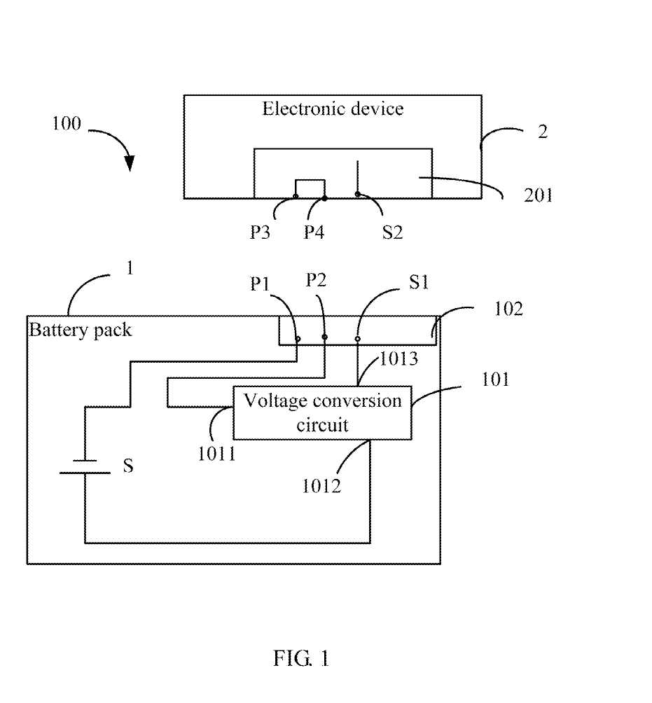

Referring to FIG. 1, a power supply system 100 includes a battery pack 1 and an electronic device 2. The battery pack 1 includes a battery S, a voltage conversion circuit 101, and a power port 102. The electronic device 2 includes a power port 201 and other function components (not shown). In the embodiment, when the battery pack 1 is connected with the electronic device 2 via the power port 102 and 201, the connection between the battery S and the voltage conversion circuit 101 is established automatically, the voltage conversion circuit 101 converts a voltage of the battery S to a predetermined voltage and power the electronic device 2 via the power ports 102 and 201. When the battery pack 1 is not connected with the electronic device 2, the connection between the battery S and the voltage conversion circuit 101 is cut off automatically, thereby avoiding power waste. In the embodiment, the electronic device 1 can be a mobile phone, a portable computer, a digital camera, a media player, or a digital photo frame.

In detail, the power port 102 of the battery port 1 includes a first connection pin P1, a second connection pin P2, and a first power pin S1. The voltage conversion circuit 101 includes a first input terminal 1011, a second input terminal 1012, and an output terminal 1013. The first connection pin P1 is connected to an end (not labeled) of the battery S, the second connection pin P2 is connected to the first input terminal 1011 of the voltage conversion circuit 101, and the second input terminal 1012 of the voltage conversion circuit 101 is connected to the other end (not labeled) of the battery S. The output terminal 1013 is connected to the power pin S1.

When the battery pack 1 is not connected to the electronic device 2, the connection between the first connection pin P1 and the second connection pin P2 is cut off. Then the connection between the battery S and the voltage conversion circuit 10 is cut off accordingly.

The power port 201 of the electronic device 2 includes a third connection pin P3, a fourth connection pin P4, and a second power pin S2. The third connection pin P3 is electrically connected to the fourth connection pin P4. When the battery pack 1 is connected to the electronic device 2, the first connection pin P1, the second connection pin P2, and the first power pin S1 of the power port 102 are respectively connected to the third power pin P3, the fourth power pin P4, and the second power pin S2 of the power port 201. Because the third power pin P3 is electrically connected to the fourth power pin P4, the first connection pin P1 is electrically connected to the second connection pin P2 via the third power pin P3 and the fourth power pin P4. Then the first input terminal 1011 and the second input terminal 1012 of the voltage conversion circuit 20 are respectively connected to the two ends of the battery S. The voltage conversion circuit 20 converts the voltage of the battery S to the predetermined voltage and outputs the predetermined voltage to the electronic device 2 via the first power pin S1 and the second power pin S2. Obviously, the first power pin S1 and the second power pin S2 both includes an anode power pin (not shown) and a cathode power pin (not shown), when the first power pin S1 is connected to the second power pin S2, the voltage conversion circuit 20 and the electronic device 2 form a loop and then the voltage conversion circuit 20 powers the electronic device 2 via the first power pin S1 and the second power pin S2.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A power supply system comprising:
a battery pack comprising:
a battery;
a voltage conversion circuit; and
a first power port, and
an electronic device comprising a second power port;
wherein, when the battery pack is connected to the electronic device via the first power port and the second power port, the connection between the battery and the voltage conversion circuit is established, the voltage conversion circuit converts a voltage of the battery to a predetermined voltage and power the electronic device via the first power port and the second power port; when the battery pack is not connected with the electronic device, the connection between the battery and the voltage conversion circuit is cut off.

2. The power supply system according to claim 1, wherein the first power port comprises a first connection pin, a second connection pin, and a first power pin, the voltage conversion circuit comprises a first input terminal, a second input terminal, and an output terminal; the first connection pin is connected to an end of the battery, the second connection pin is connected to the first input terminal of the voltage conversion circuit, the second input terminal of the voltage conversion circuit is connected to the other end of the battery, the output terminal is connected to the power pin.

3. The power supply system according to claim 2, wherein when the battery pack is not connected to the electronic device, the connection between the first connection pin and the second connection pin is cut off.

4. The power supply system according to claim 2, wherein the second power port comprises a third connection pin, a fourth connection pin, and a second power pin, the third connection pin is electrically connected to the fourth connection pin.

5. The power supply system according to claim 4, wherein when the battery pack is connected to the electronic device, the first connection pin, the second connection pin, and the first power pin of the first power port are respectively connected to the third power pin, the fourth power pin, and the second power pin of the second power port; the first connection pin is electrically connected to the second connection pin via the third power pin and the fourth power pin, then the first input terminal and the second input terminal of the voltage conversion circuit are respectively connected to the two ends of the battery, the voltage conversion circuit converts the voltage of the battery to the predetermined voltage and outputs the predetermined voltage to the electronic device via the first power pin and the second power pin.

6. The power supply system according to claim 1, wherein the electronic device is one selected from the group consisting of a mobile phone, a portable computer, a digital camera, a media player, and a digital photo frame.

7. A battery pack comprising:
a battery;
a voltage conversion circuit comprising a first input terminal, a second input terminal, and an output terminal; and
a power port comprising a first connection pin, a second connection pin, and a first power pin;
wherein, the first connection pin is connected to an end of the battery, the second connection pin is connected to the first input terminal of the voltage conversion circuit, the second input terminal of the voltage conversion circuit is connected to the other end of the battery, the output terminal is connected to the power pin.

8. The battery pack according to claim 7, wherein when the battery pack is not connected with an electronic device, the connection between the first connection pin and the second connection pin is cut off.
